(19) United States
(12) Patent Application Publication
(10) Pub. No.: US 2008/0024467 A1
(43) Pub. Date: Jan. 31, 2008

(54) Determining sequence of frames delineated into sub-frames for displaying on display device

(76) Inventors: David C. Collins, Corvallis, OR (US); Richard Aufranc, Corvallis, OR (US); Olan C. Way, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,773

(22) Filed: Jul. 26, 2006

(51) Int. Cl. G09G 5/00

(52) U.S. Cl. 345/204

(57) ABSTRACT

The ratio of a refresh rate of a display device to a refresh rate of source video is determined. The display device is to display the source video over a repeating number of sub-frames, in sub-frame order. The sequence of frames of the source video is determined for the display device that maintains the ratio. The sequence of frames is delineated so that each frame is represented by the number of sub-frames over which the display device displays the source video. The sequence of frames as delineated by the sub-frames is adjusted to ensure as much as possible that each frame is represented by the same number of sub-frames within the sequence. The source video is displayed on the display device using the sequence of frames as delineated and as adjusted.

### BACKGROUND

A display device typically displays image data by refreshing its display of the image data a number of times per second, which is referred to as the refresh rate of the display device. A typical refresh rate is 60 hertz (60 Hz), such that the display of image data is refreshed 60 per second. However, some source video data has an inherent refresh rate that is different than the refresh rate of the display device on which it is displayed. For example, many movies are recorded at 24 frames-per-second (24 fps), which corresponds to a refresh rate of the source video data of 24 Hz.

To convert the refresh rate of 24 fps source video data for display on a 60 Hz refresh rate display device, a common approach that is used is known as 3:2 pulldown. In 3:2 pulldown for a 60 Hz refresh rate display device, each frame of the source video data is duplicated two or three times. For instance, a sequence of frames A-B-C-D-E-F within the source video data may be reproduced as A-A-B-B-B-C-C-D-D-D-E-E-F-F-F when being displayed by the display device. Because sixty divided by 24 equals a ratio of 2.5, duplicating the frames of the source video data in this manner preserves the ratio of the display device refresh rate to the refresh rate of the source video data.

However, 3:2 pulldown introduces a stuttering artifact known as judder. Because some of the frames are duplicated twice, and others are duplicated three times, horizontal or vertical motion within the source video data becomes jerky and not smooth. As such, viewers may perceive the display device in question as not being a high-quality display device for displaying image source data recorded at 24 fps.

### BRIEF DESCRIPTION OF THE DRAWINGS

FIG. 1 is a diagram of the general approach by which a modulator having a given resolution can be employed to yield the display of image data with a greater resolution by using a physically adjustable aiming mechanism, according to an embodiment of the invention.

FIG. 2 is a diagram of a frame of image data divided into a number of sub-frames, according to an embodiment of the invention.

FIG. 3 is a flowchart of a method for at least substantially removing judder when displaying source video on a display device that may use the approach of FIG. 1, according to an embodiment of the invention.

FIGS. 4A, 4B, 5A, 5B, 6A, and 6B are diagrams depicting sequences of frames or sub-frames of source video data after performance of one or more of the parts of the method of FIG. 3, according to varying embodiments of the invention.

FIG. 7 is a diagram of a representative display device, according to an embodiment of the invention.

### DETAILED DESCRIPTION OF THE DRAWINGS

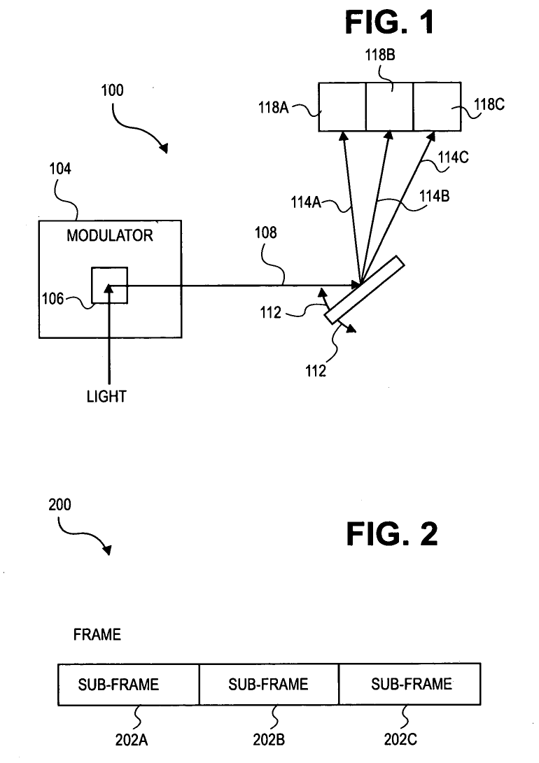

FIG. 1 shows a general approach 100 by which a light modulator 104 having a given resolution can be employed to yield the display of image data with a greater resolution, according to an embodiment of the invention. The approach 100 is exemplarily described in relation to a single pixel area 106 of the modulator 104. However, the approach 100 is the same for all the pixels of the modulator 104. Furthermore, the approach 100 may be that which is more particularly described in the patent application entitled “Image Display System and Method,” filed on Sep. 11, 2002, and published as US patent application publication no. 2004/0027363.

Light is directed towards the modulator 104, as indicated by the arrow 102. The modulator 104 may be a digital micromirror device (DMD), or another type of light modulator. The pixel area 106 of the modulator 104 specifically modulates the light in accordance with one of three pixels of image data in the embodiment of FIG. 1. The pixel area 106 may correspond to an individual micromirror within a DMD, for instance. The light as modulated by the pixel area 106 is directed towards an aiming mechanism 110, as indicated by the arrow 108. The aiming mechanism 110 may be or include a mirror, a lens, a refractive plate of refractory glass, or another type of aiming mechanism. The aiming mechanism 110 is able to move back and forth, as indicated by the arrows 112. That is, the aiming mechanism 110 is able to be physically adjusted. As depicted in FIG. 1, the aiming mechanism 110 is reflective, but can also be refractive. That is, the aiming mechanism 110 may be a reflective aiming mechanism, or a refractive aiming mechanism. The aiming mechanism 110 may alternatively be referred to as an image shifter, or an image-shifting mechanism.

When the pixel area 106 has modulated the light in accordance with the first pixel of the image data, the aiming mechanism 110 directs the light to the position 118A, as indicated by the arrow 114A. When the pixel area 106 has modulated the light in accordance with the second pixel of the image data, the aiming mechanism 110 directs the light to the position 118B, as indicated by the arrow 114B. When the pixel area 106 has modulated the light in accordance with the third pixel of the image data, the aiming mechanism 110 directs the light to the position 118C, as indicated by the arrow 114C. The positions 118A, 118B, and 118C, collectively referred to as the positions 118, are depicted in FIG. 1 as being adjacent positions, but in other embodiments may be non-adjacent, or may be overlapping.

Physically adjusting the aiming mechanism 110 depending on the pixel of the image data in accordance with which the pixel area 106 of the modulator 104 is currently modulating the light allows the pixel area 106 to be used for more. than one pixel of the image data. With respect to all the pixel areas of the modulator 104, this approach 100 allows for the display of image data with greater resolution than the number of pixel areas of the modulator 104 itself. The approach 100 has been described in relation to the pixel area 106 being able to be used for three pixels. However, in other embodiments, the approach 100 may be used so that each pixel area of the modulator 104 can be used for two pixels, or more than three pixels, as well.

Furthermore, the pixel area 106 may modulate the light in accordance with elements of the image data other than individual pixels. For instance, the pixel area 106 may modulate the light in accordance with a first sub-pixel of a given pixel, then modulate the light in accordance with a second sub-pixel of the same pixel, and finally modulate the light in accordance with a third sub-pixel of the same pixel. In such an embodiment, the aiming mechanism 110 may direct the light as modulated by the pixel area 106 in accordance with the first sub-pixel to the position 118A, direct the light as modulated by the pixel area 106 in accordance with the second sub-pixel to the position 118B, and finally direct the light as modulated by the pixel area 106 in accordance with the third sub-pixel to the position 118C.

FIG. 2 shows a representative frame 200 of image data that can be used in conjunction with the approach 100 of FIG. 1, according to an embodiment of the invention. The frame 200 is divided into a first sub-frame 202A, a second sub-frame 202B, and a third sub-frame 202C, collectively referred to as the sub-frames 202. Each of the sub-frames 202 may in one embodiment contain one-third of the pixels of the image data. In another embodiment, each of the sub-frames 202 may contain one-third of the sub-pixels of all the pixels of the image data.

With respect to the positions 118 and the pixel area 106 in FIG. 1, the sub-frame 202A contains the part of the image data that the pixel area 106 modulates light in accordance therewith while the aiming mechanism 110 is directing this light onto the position 118A, as indicated by the arrow 114A. Similarly, the sub-frame 202B contains the part of the image data that the pixel area 106 modulates light in accordance therewith while the aiming mechanism 110 is directing this light onto the position 118B, as indicated by the arrow 114B. Likewise, the sub-frame 202C contains the part of the image data that the pixel area 106 modulates light in accordance therewith while the aiming mechanism 110 is directing this light onto the position 118C, as indicated by the arrow 114C. Thus, by dividing each frame of the image data into sub-frames, the modulator 104 modulates light in accordance with the different sub-frames as the aiming mechanism 110 directs this modulated light to different positions.

Therefore, in at least some embodiments, it can be said that the approach 100 of FIG. 1 is such that image data, or source video, is displayed over a repeating number of sub-frames, in sub-frame order. Thus, a first sub-frame is displayed at the position 118A, as indicated by the arrow 114A, a second sub-frame is displayed at the position 118B, as indicated by the arrow 114B, and a third sub-frame is displayed at the position 118C, as indicated by the arrow 114C. This process then repeats, where after a first sub-frame is displayed at the position 118A, a second sub-frame is displayed at the position 118B, a third sub-frame is displayed at the position 118C, a first sub-frame is again displayed at the position 118A, and so on. It is noted that the terms “image data” and “source video” are used synonymously herein, where such data or video includes potentially moving picture data, such as movies, video games, computer image data, and so on, as can be appreciated by those of ordinary skill within the art.

Furthermore, it is noted, however, that in the approach 100 of FIG. 1, the sub-frame of the image data, or source video, that is displayed at one of the positions 118 does not have to correspond to the same frame of the image data, or source video, that is displayed at the other of the positions 118. For instance, each of a first frame and a second frame may be divided into three sub-frames, such as has been exemplarily depicted in FIG. 2. The first sub-frame of the first frame may be displayed at the position 118A, the second sub-frame of the first frame may be displayed at the position 118B, and the third sub-frame of the first frame may be displayed at the position 118C. Thereafter, the first sub-frame of the first frame may again be displayed at the position 118A. Next, however, the second sub-frame of the second frame may be displayed at the position 118B, and then the third sub-frame of the second frame may be displayed at the position 118C.

Thus, the approach 100 of FIG. 1 displays frames of image data, or source video, over a repeating number of sub-frames in sub-frame order in that a first sub-frame is displayed at the position 118A, then a second sub-frame is displayed at the position 118B, and finally a third sub-frame is displayed at the position 118C, before repeating this process at the position 118A again. However, the frames of which these sub-frames are a part do not have to be identical for a given first, second, and third sub-frames displayed in order at the positions 118A, 118B, and 118C. That is, in the example of the previous paragraph, the first sub-frame displayed at the position 118A may be from a first frame, whereas the second and the third sub-frames displayed at the positions 118B and 118C may be from a second frame. Stated another way, the approach 100 of FIG. 1 allows for a new frame of image data, or source video, to be displayed beginning at any of the positions 118, and not just at the first position 118A.

For instance, in the example of the previous paragraphs, the second frame began to be displayed at the position 118B. However, the approach 100 of FIG. 1 may in one embodiment have to have the first sub-frame of a given frame be displayed at the position 118A, the second sub-frame of a given frame be displayed at the position 118B, and the third sub-frame of a given frame be displayed at the position 118C. Thus, in the example of the previous paragraphs where the second frame began displayed at the position 118B, the second sub-frame of this second frame is displayed at the position 118B, and not, for instance, the second sub-frame of the first frame being displayed at the position 118B. This is why it is said that the approach 100 displays frames of image data, or source video in sub-frame order, such that a first sub-frame is displayed, then a second sub-frame is displayed, and then a third sub-frame is displayed, regardless of the frames of which these sub-frames are a part.

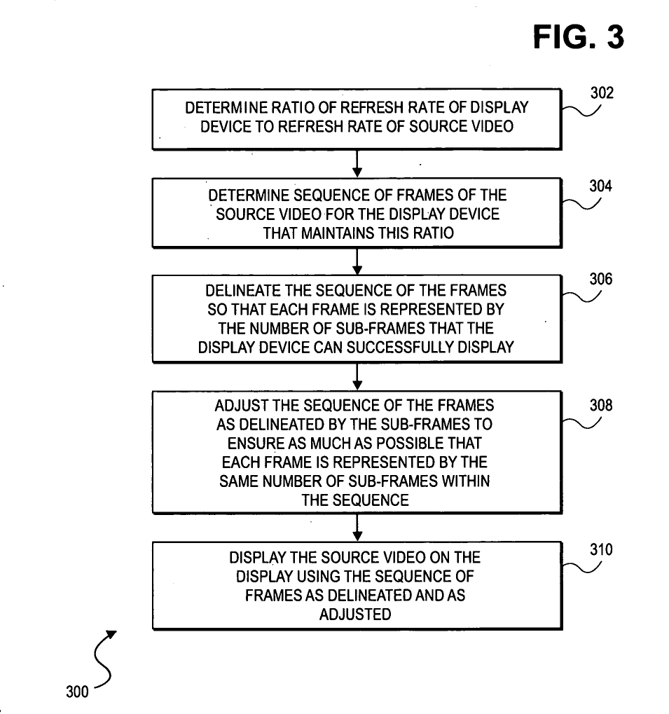

FIG. 3 shows a method 300 for displaying source video using an approach like the approach 100 of FIG. 1 in a way that at least substantially eliminates judder, according to an embodiment of the invention. The method 300 is described in relation to source video, or image data, which has a given refresh rate, and in relation to a display device on which the source video is displayed and that has a different refresh rate. In particular, the method 300 is described in reference to two different examples.

In the first example, the source video has a refresh rate of 24 frames-per-second (fps), or hertz (Hz), while the display device has a refresh rate of 60 Hz and can display two different sub-frames at different positions in succession. In the second example, the source video has a refresh rate of 75 Hz while the display device has a refresh rate of 60 Hz and can display three different sub-frames at different positions in succession, as is particularly depicted in the example of FIG. 1. The method 300 may, however, be employed for any refresh rate source video and for any refresh rate display device, as can be appreciated by those of ordinary skill within the art. For example, the source video may have a refresh rate of 60 Hz while the display device has a refresh rate of 50 Hz. The display device may further be able to display any number of sub-frames at different positions in succession greater than one.

First, the ratio of the refresh rate of the display device to the refresh rate of the source video is determined (302). In the examples that have been described, this ratio is unequal to one, and can be greater than or less than one. Particularly, in the first example, the refresh rate is 60:24, or 5:2, or 2.5. For example purposes, the source video in the first example is said to include frames organized in successive sequences of frames A-B-C-D, where each Y equaling A, B, C, or D refers to a different frame. Also for example purposes, the display device in the first example is said to be able to display any frame X over two sub-frames X₁ and X₂ in succession at different positions.

In the second example, the refresh rate is 60:75, or 4:5, or 0.8. The source video in the second example is said to include frames organized in successive sequences of frames A1-B1-C1-D1-E1-A2-B2-C2-D2-E2-A3-B3-C3-D3-E3-A4-B4-C4-D4-E4-A5-B5-C5-D5-E5, where each XY, X equaling A, B, C, or D and Y equaling 1, 2, 3, or 4, refers to a different frame. The display device in the second example is said to be able to display any frame X over three sub-frames X₁, X₂, and X₃ in succession at different positions.

Next, a sequence of frames of the source video is determined for the display device that maintains the ratio of the refresh rate of the display device to the refresh rate of the source video (304). Where the ratio is greater than one, one or more of the frames are periodically duplicated within the sequence to maintain the ratio. By comparison, where the ratio is less than one, one or more of the frames are periodically removed from the sequence to maintain the ratio.

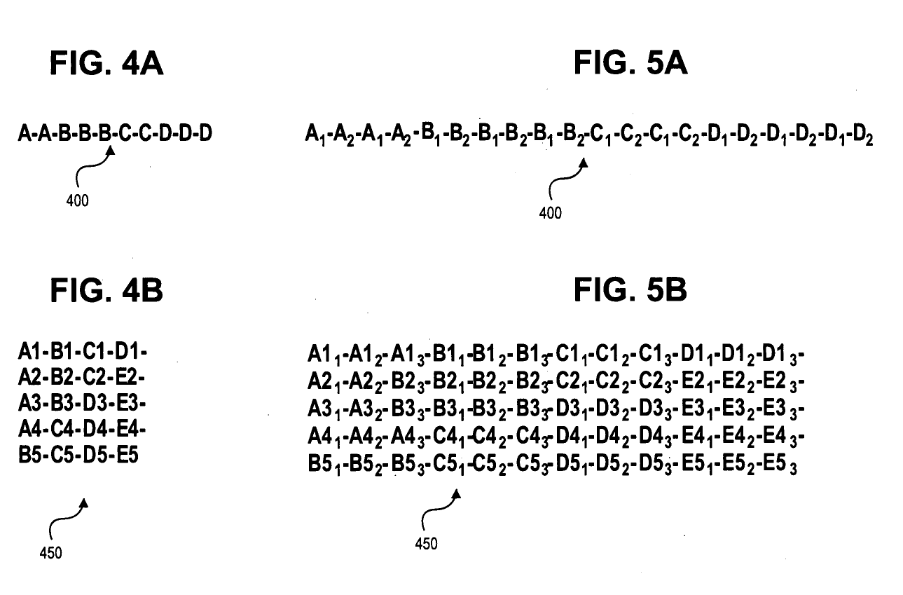

FIG. 4A shows an example of a sequence of frames 400 of the source video for the display device that maintains a refresh rate of 60:24, or 2.5, according to an embodiment of the invention. The sequence 400 of FIG. 4A thus corresponds to the first example that has been described, where the display device has a refresh rate of 60 Hz, and the source video has a refresh rate of 24 fps. In the example sequence 400, the frames A and C are repeated twice, whereas the frames B and D are repeated three times to maintain the ratio. As such, if the sequence 400 were displayed as depicted in FIG. 4A, judder would result, since the frames A and C are displayed one-third less than the frames B and D by the display device.

FIG. 4B shows an example of a sequence of frames 450 of the source video for the display device that maintains a refresh rate of 60:75, or 0.8, according to an embodiment of the invention. The sequence 450 of FIG. 4B thus corresponds to the second example that has been described, where the display device has a ratio of 60 Hz, and the source video has a refresh rate of 75 Hz. In the example sequence 450, for each set of frames XY, where Y stays constant at 1, 2, 3, or 4, one of the frames AY, BY, CY, DY, and EY is not displayed to maintain the ratio. Therefore, in the first set of frames X1, the frame E1 is not displayed. In the second set X2, the frame D2 is not displayed; in the third set X3, the frame C3 is not displayed; and in the fourth set X4, the frame B4 is not displayed. Finally, in the fifth set X5, the frame A5 is not displayed. As such if the sequence 450 were displayed as depicted in FIG. 4B, judder would result, since a complete frame from each set of frames XY is not displayed by the display device.

Referring back to FIG. 3, the sequence of the frames that has been determined is delineated, so that each frame is represented by the number of different sub-frames that the display device can successively display (306). For instance, in the example of FIG. 1, the display device can display three different sub-frames, corresponding to the three positions 118. Thus, each frame is replaced by a corresponding number of sub-frames of that frame that can be displayed by the display device.

FIG. 5A shows an example of the sequence of frames 400 of FIG. 4A being delineated by the number of sub-frames that the display device can successively display at different positions, according to an embodiment of the invention. The sequence of FIG. 5A thus corresponds to the first example that has been described in relation to FIG. 4A, where the display device can display two different sub-frames of each frame at different positions. Each frame X has been replaced by two sub-frames of that frame, X₁ and X₂. For example, each instance of the frame A has been replaced by the sub-frames A₁ and A₂ of the frame A. Similarly, each instance of the frame C has been replaced by the sub-frames C₁ and C₂ of the frame C, and so on. As in FIG. 4A, judder would result if the sequence 400 of FIG. 5A were displayed, because some frames are displayed more often than other frames.

FIG. 5B shows an example of the sequence of frames 450 of FIG. 4B being delineated by the number of sub-frames that the display device can successively display at different positions, according to an embodiment of the invention. The sequence of FIG. 5B thus corresponds to the second example that has been described in relation to FIG. 4B, where the display device can display three different sub-frames of each frame at different positions. Each frame XY has been replaced by three sub-frames of that frame, XY₁, XY₂, and XY₃. For example, the frame B2 has been replaced by the sub-frames B2₁, B2₂, and B2₃ of the frame B2. Similarly, each instance of the frame D4 has been replaced by the sub-frames D4₁, D4₂, and D4₃ of the frame D4, and so on. As in FIG. 4B, judder would result if the sequence 400 of FIG. 4B were displayed, because within each set of frames XY, where Y is constant, one of the frames AY, BY, CY, DY, and EY is not displayed.

Referring back to FIG. 3, the sequence of frames as delineated by the sub-frames is adjusted to ensure as much as possible that each frame is represented by the same number of sub-frames within the sequence (308). For instance, one or more of the sub-frames of one or more of the frames within the sequence may be replaced with one or more of the sub-frames of one or more of the other frames. By ensuring as much as possible that each frame is represented by the same number of sub-frames, judder is substantially, if not completely, eliminated. The adjustment of part 308 of the method 300 of FIG. 3 can leverage the display approach of FIG. 1, in which the first sub-frame of a first frame can be followed in display by the second sub-frame of a second frame, and not necessarily by the second sub-frame of the first frame. It is noted, however, that the ratio of the refresh rate of the display device to the refresh rate of the source video is still maintained during the adjustment of part 308 of the method 300.

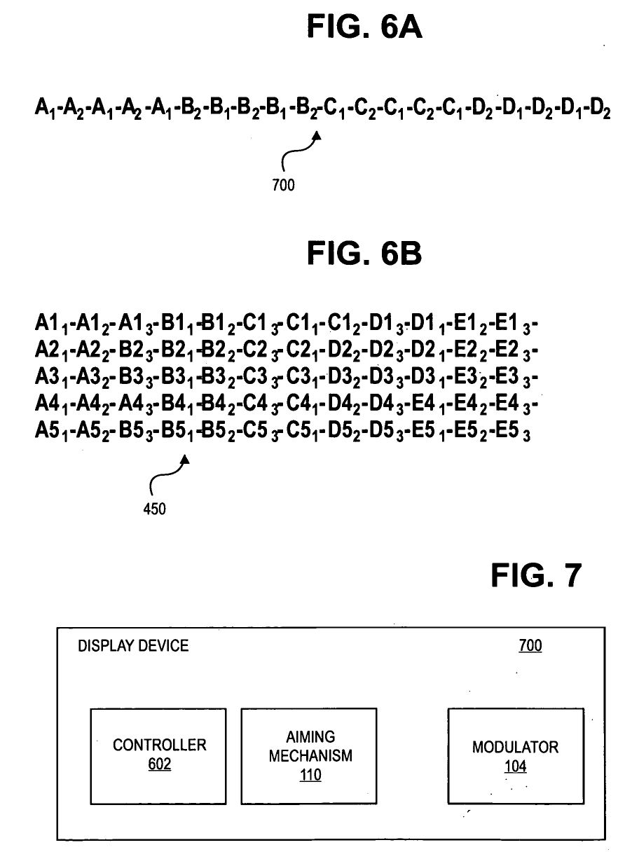

FIG. 6A shows an example of the sequence of frames 400 of FIG. 5A after being adjusted so that each frame as much as possible is represented by the same number of sub-frames within the sequence 400, according to an embodiment of the invention. The sequence of FIG. 6A thus corresponds to the first example that has been described in relation to FIGS. 4A and 5A. Unlike in FIG. 5A, where the frames A and C were represented by four sub-frames each and the frames B and D were represented by six sub-frames each, in FIG. 6A each of the frames A, B, C, and D is represented by five sub-frames. As such, judder is reduced, if not completely eliminated, by displaying the frames of the source video in accordance with the sequence 400 of FIG. 6A. Thus, in one embodiment, adjusting a sequence of frames so that as much as possible each frame is represented by the same number of sub-frames within the sequences can mean adjusting the sequence so that all the frames are indeed represented by the same number of sub-frames.

FIG. 6B shows an example of the sequence of frames 450 of FIG. 5B after being adjusted so that each frame as much as possible is represented by the same number of sub-frames within the sequence 450, according to an embodiment of the invention. The sequence of FIG. 6B thus corresponds to the second example that has been described in relation to FIGS. 4B and 5B. Unlike in FIG. 5B, where in each set of frames XY, where Y is constant, one of the frames AY, BY, CY, DY, and EY is not present, in FIG. 6B, all of the frames AY, BY, CY, DY, and EY are present for each set of frames XY, where Y is constant.

For example, for the set of frames X1, including frames A1, B1, C1, D1, and E1, three sub-frames of frames A1 and C1 are present within the sequence 450, and two sub-frames of frames B1, D1, and E1 are present. Although it is not possible to adjust the sequence so that each of the frames A1, B1, C1, D1, and E1 is represented by the same number of sub-frames, having each of these frames represented by either two or three sub-frames as in FIG. 6B is better than the situation in FIG. 5B. That is, in FIG. 5B, the frames A1, B1, C1, and D1 are represented by three sub-frames, whereas the frame E1 is represented by zero sub-frames. Thus, in one embodiment, adjusting a sequence of frames so that as much as possible each frame is represented by the same number of sub-frames within the sequence can mean adjusting the sequence so that all frames are represented (i.e., no frames are completely absent). Furthermore, such adjustment can include in one embodiment adjusting the sequence so that the number of sub-frames representing any given frame does not vary from the number of sub-frames representing any other frame by more than one.

Similarly, for the set of frames X2, including frames A2, B2, C2, D2, and E2, three sub-frames of frames B2 and D2 are present within the sequence 450, and two sub-frames of frames A2, C2, and E2 are present. For the set of frames X3, including frames A3, B3, C3, D3, and E4, three sub-frames of frames C3 and D3 are present within the sequence 450, and two sub-frames of frames A3, B3, and E3 are present. For the set of frames X4, including frames A4, B4, C4, D4, and E4, three sub-frames of frames A4 and E4 are present within the sequence 450, and two sub-frames of frames B4, C4, and D4 are present. Finally, for the set of frames X5, including frames A5, B5, C5, D5, and E5, three sub-frames of frames B5 and E5 are present within the sequence 450, and two sub-frames of frames A5, C5, and D5 are present.

Referring back to FIG. 3, the method 300 concludes by displaying the source video on the display device using the sequence of frames as delineated and as adjusted (310). Parts 302, 304, 306, and 308 may be performed prior to utilization of the display device, for typical source video refresh rates likely to be encountered, such that the display device can be programmed to yield a sequence of frames for each different source video refresh rate. Thereafter, when source video having one of these refresh rates is detected or otherwise encountered, the appropriate sequence of frames can be employed.

For example, where 24 fps source video is to be displayed by a 60 Hz display device, each successive set of four frames is displayed by using the sequence 400 of FIG. 6A. As another example, where 75 Hz source video is to be displayed by a 60 Hz display device, each successive set of twenty frames (i.e., four sub-sets of five frames each) is displayed by using the sequence 450 of FIG. 6B. As such, judder is substantially, if not completely eliminated, improving the quality of the display of the source video.

In conclusion, FIG. 7 shows a rudimentary display device 700, according to an embodiment of the invention. The display device 700 may be a front or rear projector, for instance. The display device 700 includes the modulator 104 and the aiming mechanism 110 as have been described. The display device 700 also includes a controller, which can be implemented in hardware, software, or a combination of hardware and software. The controller receives frames of source video and converts the frames to sub-frames by performing the method 300 of FIG. 3. Once the frames have been converted to sub-frames, the controller controls the modulator 104 and the aiming mechanism 110 to display the sub-frames to yield at least substantially judder-free display of the source video.

We claim:

1. A method comprising:
determining a ratio of a refresh rate of a display device to a refresh rate of a source video, the display device to display the source video over a repeating plurality of sub-frames in sub-frame order;
determining a sequence of a plurality of frames of the source video for the display device that maintains the ratio;
delineating the sequence of the frames so that each frame is represented by the plurality of sub-frames;
adjusting the sequence of the frames as delineated by the sub-frames to ensure as much as possible that each frame is represented by a same number of sub-frames within the sequence; and,
displaying the source video on the display device using the sequence as delineated and as adjusted.

2. The method of claim 1, wherein the ratio is unequal to one.

3. The method of claim 1, wherein the ratio is greater than one, such that determining the sequence of the plurality of frames comprises periodically duplicating one or more of the frames within the sequence.

4. The method of claim 1, wherein the ratio is less than one, such that determining the sequence of the plurality of frames comprises periodically removing one or more of the frames within the sequence.

5. The method of claim 1, wherein delineating the sequence of the frames so that each frame is represented by the plurality of sub-frames comprises replacing each frame within the sequence with a number of sub-frames of the frame equal to a number of the plurality of sub-frames.

6. The method of claim 1, wherein adjusting the sequence of the frames as delineated to ensure as much as possible that each frame is represented by a same number of sub-frames within the sequence comprises replacing one or more of the sub-frames of one or more of the frames with one or more of the sub-frames of one or more of other of the frames.

7. The method of claim 1, wherein adjusting the sequence of the frames as delineated to ensure as much as possible that each frame is represented by a same number of sub-frames within the sequence comprises adjusting the sequence of the frames as delineated so that each frame is represented by the same number of sub-frames within the sequence.

8. The method of claim 1, wherein adjusting the sequence of the frames as delineated to ensure as much as possible that each frame is represented by a same number of sub-frames within the sequence comprises adjusting the sequence of the frames as delineated so that each frame is represented by a number of sub-frames not varying the a number of sub-frames representing any other frame by more than one.

9. The method of claim 1, wherein the refresh rate of the source video is 24 frames-per-second (fps) and the refresh rate of the display device is 60 fps.

10. The method of claim 9, wherein determining the sequence of the plurality of frames of the source video for the display device that maintains the ratio comprises determining the sequence as A-A-B-B-B-C-C-D-D-D for any four successive frames A, B, C, and D of the source video, such that the frames A and C are each repeated twice and the frames B and D are each repeated three times within the sequence,
and wherein delineating the sequence of frames so that each frame is represented by the plurality of frames comprises delineating the sequence as A₁-A₂-A₁-A₂-B₁-B₂-B₁-B₂-B₁-B₂-C₁-C₂-C₁-C₂-D₁-D₂-D₁-D₂-D₁-D₂ for any four successive frames A, B, C, D, where Xₙ denotes sub-frame n of frame X.

11. The method of claim 9, wherein adjusting the sequence of frames as delineated to ensure as much as possible that each frame is represented by a same number of sub-frames within the sequence comprises adjusting the sequence of frames as A₁-A₂-A₁-A₂-A₁-B₂-B₁-B₂-B₁-B₂-C₁-C₂-C₁-C₂-C₁-D₂-D₁-D₂-D₁-D₂ for any four successive frames A, B, C, D, where Xₙ denotes sub-frame n of frame X.

12. A display device comprising:
a modulator to modulate light in accordance with a plurality of sub-frames of a plurality of frames of image data based on a refresh rate of the display device;
an aiming mechanism to position the light modulated by the modulator differently for each sub-frame of the frames of image data in repeating sub-frame order; and,
a controller to receive a plurality of frames of source video having a refresh rate and to convert the frames of the source video to the sub-frames of the frames of the image data in accordance with which the modulator modulates the light,
the controller adjusting a sequence of the frames of the image data in which the frames are delineated by the sub-frames and that maintains a ratio of the refresh rate of the display device to the refresh rate of the source video, to ensure as much as possible that each frame is represented by a same number of the sub-frames within the sequence.

13. The display device of claim 12, wherein the ratio is greater than one, such that one or more of the frames of the source video are periodically duplicated within the sequence of the frames of the image data.

14. The display device of claim 12, wherein the ratio is less than one, such that one or more of the frames of the source video are periodically removed from the sequence of the frames of the image data.

15. The display device of claim 12, wherein the controller adjusts the sequence of the frames as delineated to ensure as much as possible that each frame is represented by a same number of sub-frames within the sequence by replacing one or more of the sub-frames of one or more of the frames with one or more of the sub-frames of one or more of other of the frames.

16. The display device of claim 12, wherein the refresh rate of the source video is 24 frames-per-second (fps) and the refresh rate of the display device is 60 fps, and the controller adjusts the sequence of frames of the image data as A₁-A₂-A₁-A₂-A₁-B₂-B₁-B₂-B₁-B₂-C₁-C₂-C₁-C₂-C₁-D₂-D₁-D₂-D₁-D₂ for any four successive frames A, B, C, D, where Xₙ denotes sub-frame n of frame X.

17. A display device comprising:
modulating means for modulating light in accordance with a plurality of sub-frames of a plurality of frames of image data based on a refresh rate of the display device;
aiming means for positioning the light modulated by the modulating means differently for each sub-frame of a frame of image data in repeating sub-frame order; and,
controlling means for
receiving a plurality of frames of source video having a refresh rate;
converting the frames of the source video to the sub-frames of the frames of the image data in accordance with which the modulator modulates the light; and,
adjusting a sequence of the frames of the image data in which the frames are delineated by the sub-frames and that maintains a ratio of the refresh rate of the display device to the refresh rate of the source video, to ensure as much as possible that each frame is represented by a same number of the sub-frames within the sequence.

18. The display device of claim 17, wherein where the ratio is greater than one, one or more of the frames of the source video are periodically duplicated within the sequence of the frames of the image data, and where the ratio is less than one, one or more of the frames of the source video are periodically removed from the sequence of the frames of the image data.

19. The display device of claim 17, wherein the controlling means adjusts the sequence of the frames as delineated to ensure as much as possible that each frame is represented by a same number of sub-frames within the sequence by replacing one or more of the sub-frames of one or more of the frames with one or more of the sub-frames of one or more of other of the frames.

20. The display device of claim 17, wherein the refresh rate of the source video is 24 frames-per-second (fps) and the refresh rate of the display device is 60 fps, and the controlling means adjusts the sequence of frames of the image data as A₁-A₂-A₁-A₂-A₁-B₂-B₁-B₂-B₁-B₂-C₁-C₂-C₁-C₂-C₁-D₂-D₁-D₂-D₁-D₂ for any four successive frames A, B, C, D, where Xₙ denotes sub-frame n of frame X.
